(19) United States
(12) Patent Application Publication
(10) Pub. No.: US 2026/0072818 A1
(43) Pub. Date: Mar. 12, 2026

(54) METHOD FOR ACCESSING SYSTEM-ON-CHIP (SOC) MEMORY FROM USER SPACE

(71) Applicant: QUALCOMM Incorporated, San Diego, CA (US)

(72) Inventors: Hari Prasad SAMPATIRAO, Fremont, CA (US); Sandip HOMCHAUDHURI, San Jose, CA (US); Guido Robert FREDERIKS, Watsonville, CA (US)

(21) Appl. No.: 18/829,868

(22) Filed: Sep. 10, 2024

(51) Int. Cl. G06F 12/02

(52) U.S. Cl. CPC G06F 12/0223; G06F 2212/657

(57) ABSTRACT

The present disclosure is directed to a method for accessing memory. The method includes mapping an address space for the memory to an address space for a kernel space. The method includes mapping the address space for the memory to an address space for a user space using the kernel space. The method includes accessing the memory via the address space for the kernel space and the address space for the user space.

Aspects of the present disclosure generally relate to accessing memory of a system-on-a-chip and, more particularly, to techniques for accessing the memory from a user space.

### BACKGROUND

An operating system for a central processing unit (CPU) includes two distinct areas of memory, a kernel space and a user space. The kernel space runs complex features and certain applications (e.g., legacy applications) that are based out of the operating system (e.g., Linux), whereas the user space runs user applications. The kernel space includes a peripheral driver that allows the kernel space to communicate with a peripheral device, such as a system-on-a-chip (SoC) having memory (e.g., a plurality of registers). Using the peripheral driver, the kernel space may access the memory of the SoC to perform read/write operations.

An application running in the user space cannot directly access the peripheral device. Instead, the application communicates with the peripheral device via the kernel space. More specifically, the application passes messages (e.g., system calls) to the peripheral driver running in the kernel space using a system call interface (e.g., an application programming interface associated with the peripheral driver). The peripheral driver may handle events related to the messages. However, this indirect manner of communication between user applications (e.g., running in the user space) and the peripheral device can cause significant delays in packet processing and is typically error prone.

Accordingly, techniques for accessing peripheral devices directly from the user space are desired.

### BRIEF SUMMARY

In one aspect, a method for accessing memory is provided. The method includes: mapping an address space for the memory to an address space for a kernel space; mapping the address space for the memory to an address space for a user space using the kernel space; and accessing the memory via the address space for the kernel space and the address space for the user space.

In another aspect, a non-transitory computer-readable medium including instructions to be executed in a processor is provided. The instructions, when executed in the processor, cause the processor to perform a method for accessing memory. The method typically includes: mapping an address space for the memory to an address space for a kernel space; mapping the address space for the memory to an address space for a user space using the kernel space; and accessing the memory via the address space for the kernel space and the address space for the user space.

In yet another aspect, an apparatus is provided. The apparatus includes one or more processors configured to perform a method for accessing memory. The method typically includes: mapping an address space for the memory to an address space for a kernel space; mapping the address space for the memory to an address space for a user space using the kernel space; and accessing the memory via the address space for the kernel space and the address space for the user space.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a framework for an operating system of a central processing unit according to some aspects of the present disclosure.

FIG. 2A depicts an electronic device including a kernel space driver and a user space driver having separate data paths to access memory of a peripheral device according to some aspects of the present disclosure.

FIG. 2B depicts another electronic device including a kernel space driver and a user space driver having separate data paths to access memory of a peripheral device according to some aspects of the present disclosure.

FIG. 2C depicts yet another electronic device including a kernel space driver and a user space driver having separate data paths to access memory of a peripheral device according to some aspects of the present disclosure.

FIG. 2D depicts a first electronic device including a kernel space driver having a dedicated data path to access memory of a peripheral device and a second electronic device including a user space driver having a dedicated data path to access the memory of the peripheral device according to some aspects of the present disclosure.

FIG. 3A depicts a first technique for synchronizing communications on a kernel space data path and a user space data path according to some aspects of the present disclosure.

FIG. 3B depicts a second technique for synchronizing communications on a kernel space data path and a user space data path according to some aspects of the present disclosure.

FIG. 3C depicts a third technique for synchronizing communications on a kernel space data path and a user space data path according to some aspects of the present disclosure.

FIG. 4 depicts a method for accessing memory of a peripheral device according to some aspects of the present disclosure.

FIG. 5 depicts an example processing system in which a central processing unit may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatuses for accessing memory from a user space.

Example aspects are directed to operating systems, such as Linux based operating systems. As previously mentioned, operating systems typically include a kernel space and a user space. The kernel space may have direct access to a peripheral device, such as a SoC having memory. The user space may have indirect access to the peripheral device via the kernel space. However, in some instances, this indirect access to the peripheral device may be undesirable. For example, applications running in the user space and having a real-time requirement (that is, the ability to process packets in real-time) may experience diminished performance (e.g., latency, processing errors, etc.) due to the user space having to communicate with the peripheral device via the kernel space.

Example aspects are directed to techniques for accessing a peripheral device from a user space. For example, the disclosed techniques generally include mapping an address space of memory in a peripheral device to an address space for the kernel space. For example, a driver running in the kernel space may map the address space of the memory through an interface standard (e.g., peripheral component interface) that the kernel space and the peripheral device use to communicate with one another. The disclosed techniques further include remapping the address space of the memory using the kernel space's userspace input/output (UIO) framework. This in turn allows the userspace to directly access the memory of the peripheral device through the UIO mapped memory (that is, the remapped address space of the memory). In this manner, the disclosed techniques allow drivers in the kernel space and the user space, respectively, to directly access the peripheral device at the same time.

### Example Framework for Operating System of Central Processing Unit (CPU)

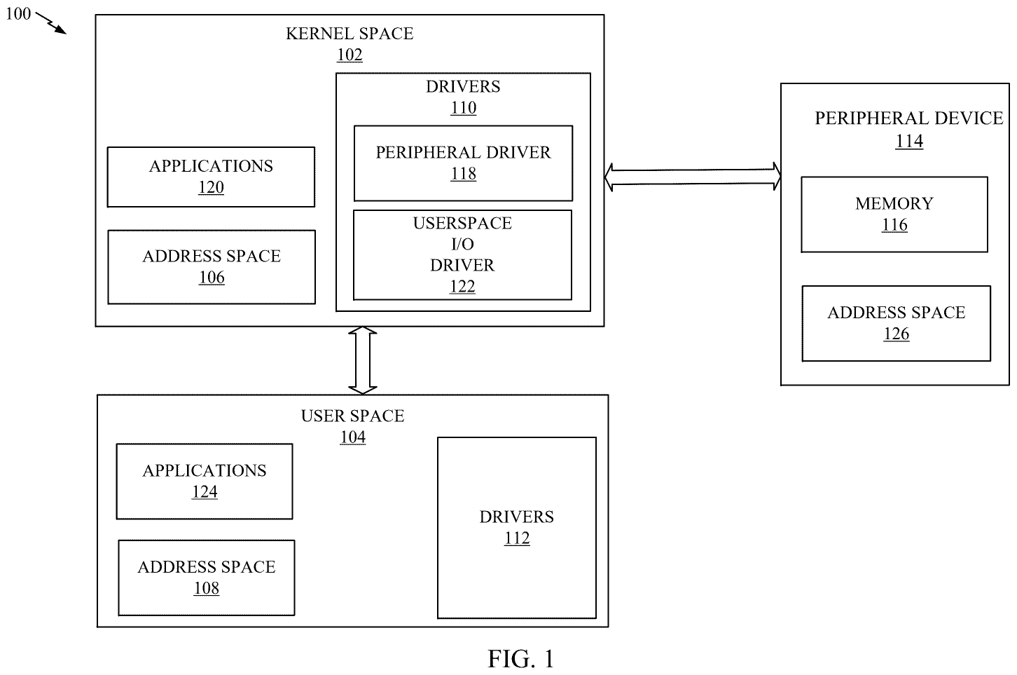

FIG. 1 depicts a framework 100 of an operating system for a central processing unit according to some aspects of the present disclosure. As shown, the framework 100 includes a kernel space 102 and a user space 104. The kernel space 102 and the user space 104 each include their own address space. For example, the kernel space 102 includes an address space 106 (e.g., unified virtual address space) that is shared across all components of the kernel space 102. Likewise, the user space 104 includes an address space 108 (e.g., unified virtual address space) that is shared across all components of the user space 104.

As illustrated, the kernel space 102 includes drivers 110 and the user space 104 includes drivers 112. The drivers 110 in the kernel space 102 have direct access to system resources and hardware, whereas the drivers 112 in the user space 104 have restricted access to the system resources and hardware. For example, the drivers 110 in the kernel space 102 may directly access and manipulate the entire physical memory of the operating system, whereas the drivers 112 in the user space 104 may only access and manipulate memory regions that are explicitly mapped and allocated to them by the kernel space 102. Furthermore, the drivers 110 in the kernel space 102 generally have lower latency and better performance compared to drivers 112 in the user space 104 because, unlike the drivers 112 in the user space 104, the drivers 110 in the kernel space 102 can directly interact with hardware, such as a peripheral device 114 (e.g., a SoC having memory), without having the overhead of crossing the user-kernel boundary. Stated another way, the drivers 110 in the kernel space 102 may communicate directly with the peripheral device 114, whereas the drivers 112 in the user space 104 may communicate indirectly with the peripheral device 114 via the kernel space 102. Examples of communications between the peripheral device and the operating system, specifically the kernel space 102 and the user space 104 thereof, may include requests to read data from memory 116 of the peripheral device 114 and write data to the memory 116 of the peripheral device 114.

In some aspects, the drivers 110 included in the kernel space 102 may include a peripheral driver 118 configured to provide a standardized and secure interface (e.g., a peripheral component interface) for applications to interact with the peripheral device 114. For example, applications 120 running in the kernel space 102 may interact with the peripheral device 114 via the peripheral driver 118 to, as previously mentioned, read data from the memory 116 of the peripheral device 114 and/or write data to the memory 116 of the peripheral device 114. In some aspects, the operating system may provide a system call interface by which the applications 120 running in the kernel space 102 may interact with the peripheral driver 118.

Example aspects of the present disclosure are directed to techniques for mapping an address space 126 for the memory 116 of the peripheral device 114 to both the kernel space 102 and the user space 104. By mapping the address space 126 for the memory 116 to both the kernel space 102 and the user space 104, the disclosed techniques may provide a kernel space data path between the kernel space 102 and the peripheral device 114 and a user space data path between the user space 104 and the peripheral device 114. The user space data path may be separate from the kernel space data path such that the kernel space 102 and the user space 104 may access the peripheral device at the same time. Furthermore, since the user space 104 may directly access the peripheral device 114 via the user space data path, latency associated with such operations (e.g., read/write) performed by applications 124 running in the user space 104 may be improved compared to conventional techniques in which the applications 124 interact with the peripheral device 114 via the drivers 110 running in the kernel space 102.

### Example Electronic Devices Having Independent Kernel Space and User Space Data Paths to Memory of a Peripheral Device

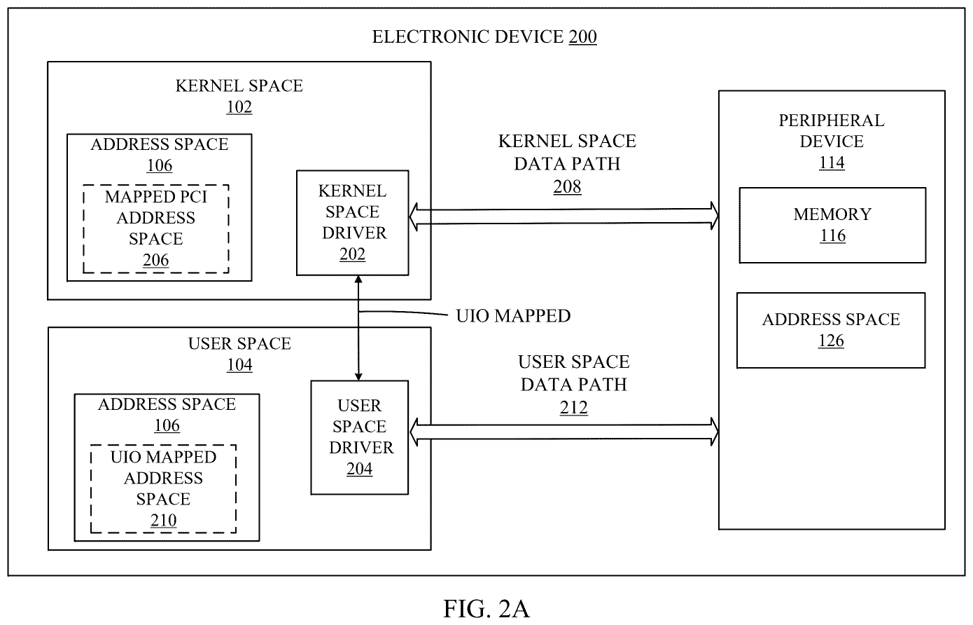

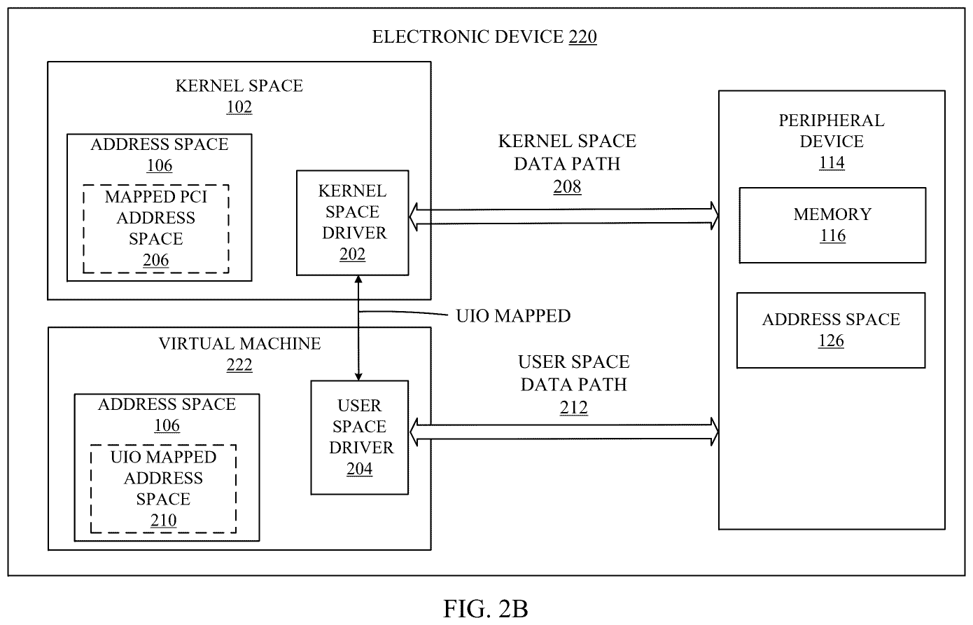

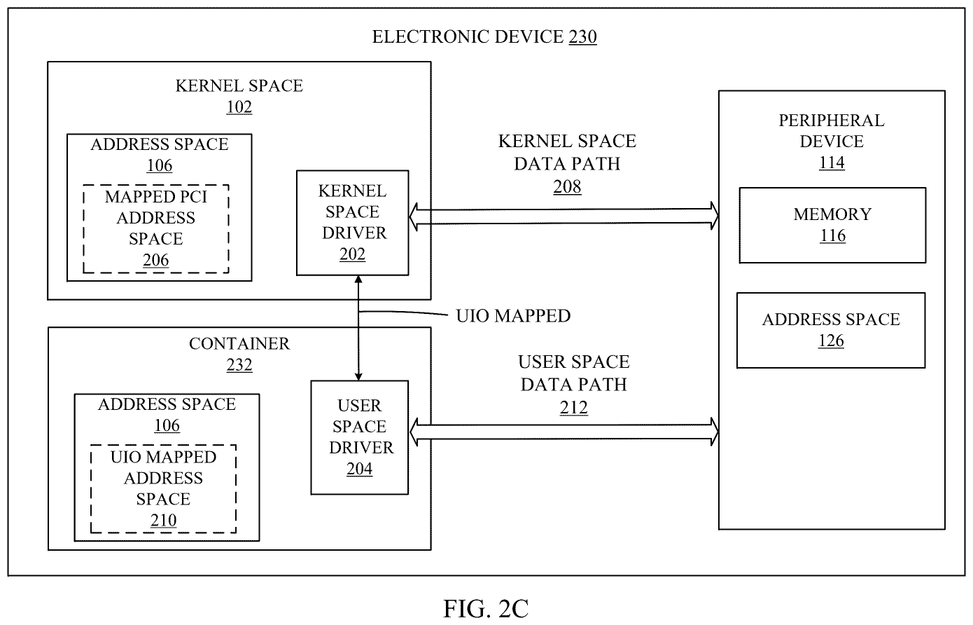

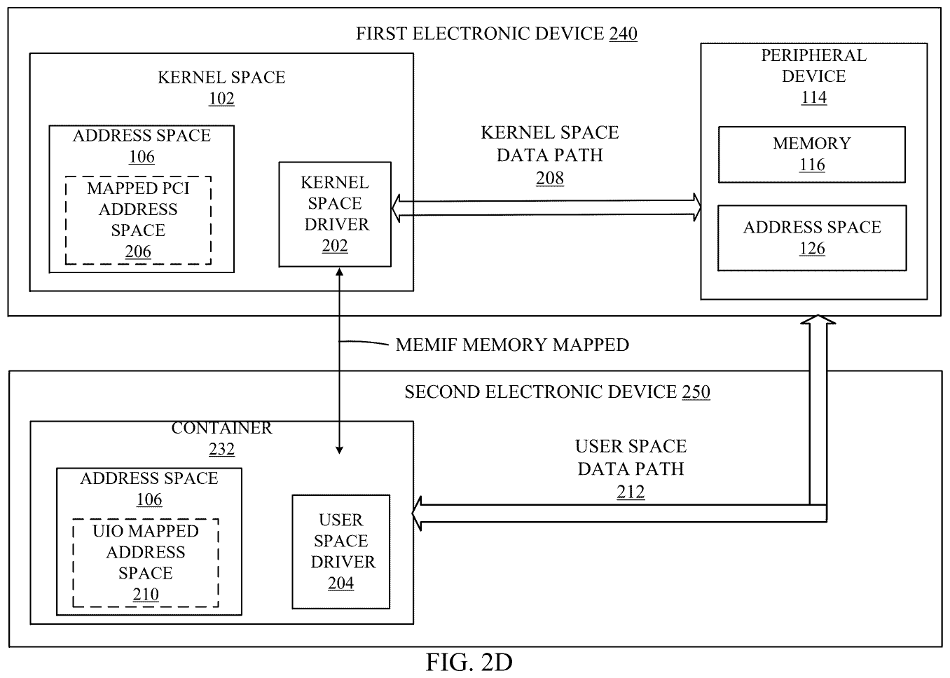

FIG. 2A illustrates an electronic device 200 including a kernel space driver 202 and a user space driver 204. In some aspects, the electronic device 200 may be a network device (e.g., a router) that processes data packets associated with a wireless standard (e.g., Wifi). It should be understood, however, that the scope of the present disclosure is not intended to be limited to network devices and may therefore be applicable to other types of electronic devices in which both the kernel space driver 202 and the user space driver 204 may be deployed.

In some aspects, the kernel space driver 202 may map the address space 126 of the memory 116 of the peripheral device 114 to the address space 106 of the kernel space 102. For example, in some aspects, the kernel space driver 202 may map the memory-mapped regions (e.g., address space 126) of the memory 116 of the peripheral device 114 into the address space 106 of the kernel space 102 to allow the kernel space driver 202 to directly access and control the memory 116 (e.g., registers) of the peripheral device 114. The memory-mapped regions of the peripheral device 114 mapped into the address space 106 of the kernel space 102 by the kernel space driver 202 are illustrated as mapped PCI address space 206 that provides the kernel space driver 202 direct access (e.g, via kernel space data path 208) to the memory 116 of the peripheral device 114.

In some aspects, the kernel space driver 202 may remap the mapped PCI address space 206 to the user space 104 using a user space input/output (UIO) framework of the kernel space 102. The remapped PCI address space 206 is illustrated in the address space 106 of the user space 104 as UIO mapped address space 210 that provides the user space driver 204 direct access (e.g., via user space data path 212) to the memory 116 of the peripheral device 114. In this manner, the kernel space driver 202 and the user space driver 204 may access the memory 116 of the peripheral device 114 at the same time using separate data paths (e.g., kernel space data path 208 and user space data path 212).

FIG. 2B illustrates an electronic device 220 according to some aspects of the present disclosure. As illustrated, the electronic device 220 in FIG. 2B is substantially similar to the electronic device 200 discussed above with reference to FIG. 2A. For example, the electronic device 220 of FIG. 2B includes several of the same components of the electronic device 200 of FIG. 2A. Accordingly, the same reference numbers are reused for those like components. However, in contrast to the electronic device 200 of FIG. 2A, the user space driver 204 is implemented in a virtual machine 222.

FIG. 2C illustrates an electronic device 230 according to some aspects of the present disclosure. As illustrated, the electronic device 230 in FIG. 2C is substantially similar to the electronic device 220 discussed above with reference to FIG. 2B. For example, the electronic device 230 of FIG. 2C includes several of the same components of the electronic device 220 of FIG. 2B. Accordingly, the same reference numbers are reused for those like components. However, in contrast to the electronic device 220 of FIG. 2B, the user space driver 204 is implemented in a container 232 instead of a virtual machine.

FIG. 2D illustrates a first electronic device 240 and a second electronic device 250 according to some aspects of the present disclosure. The first electronic device 240 and the second electronic device 250 are substantially similar to the electronic device 230 in FIG. 2C. Accordingly, the same reference numbers are reused for those like components.

In some aspects, the kernel space driver 202 in the first electronic device 240 may map the address space 126 of the memory 116 of the peripheral device 114 to the address space 106 of the kernel space 102. For example, in some aspects, the kernel space driver 202 may map the memory-mapped regions (e.g., address space 126) of the memory 116 of peripheral device 114 into the address space 106 of the kernel space 102 to allow the kernel space driver 202 to directly access and control the memory 116 (e.g., registers) of the peripheral device 114. The memory-mapped regions of the peripheral device 114 mapped into the address space 106 of the kernel space 102 by the kernel space driver 202 are illustrated as mapped PCI address space 206 that provides the kernel space driver 202 direct access (e.g, via kernel space data path 208) to the memory 116 of the peripheral device 114.

As illustrated, the user space driver 204 running in the container 232 may be onboard the second electronic device 250. Since the user space driver 204 is running in a different device than the kernel space driver 202, the user space driver 204 may memory may the mapped PCI address space 206 using a memif interface. It should be understood that the memif interface is a type of interface used in the context of virtual network and cloud infrastructure. The memif interface allows for efficient data transfer without the overhead of traditional network interfaces and system calls.

In some aspects, the user space driver 202 depicted in FIGS. 2A, 2B, 2C, and 2D may be a poll mode driver. It should be understood that poll mode drivers operate in a polling mode rather than using interrupts. More specifically, poll mode drivers actively check for incoming packets instead of relying on interrupts to notify the poll mode driver of new data packets.

### Example Techniques for Synchronizing Kernel Space Driver and User Space Driver

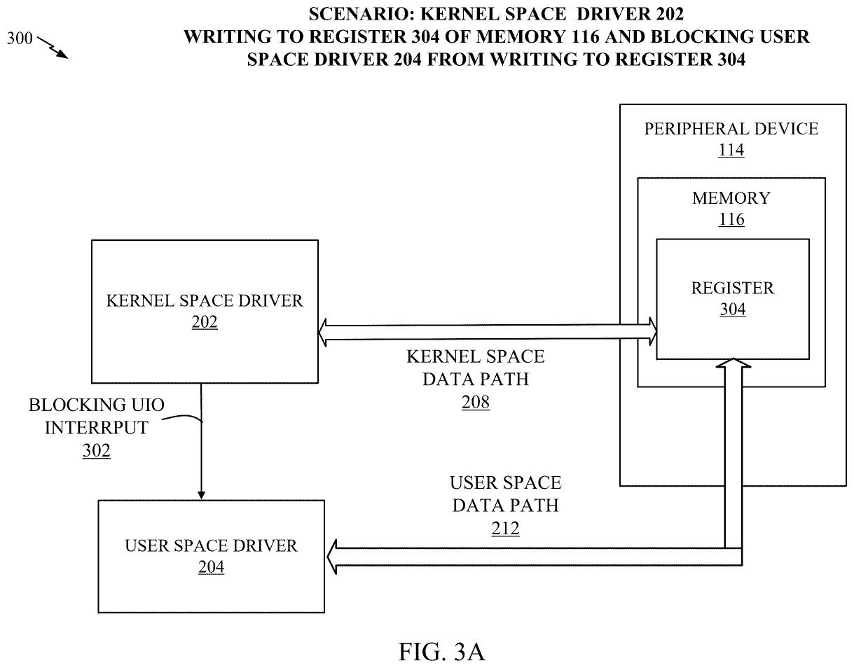

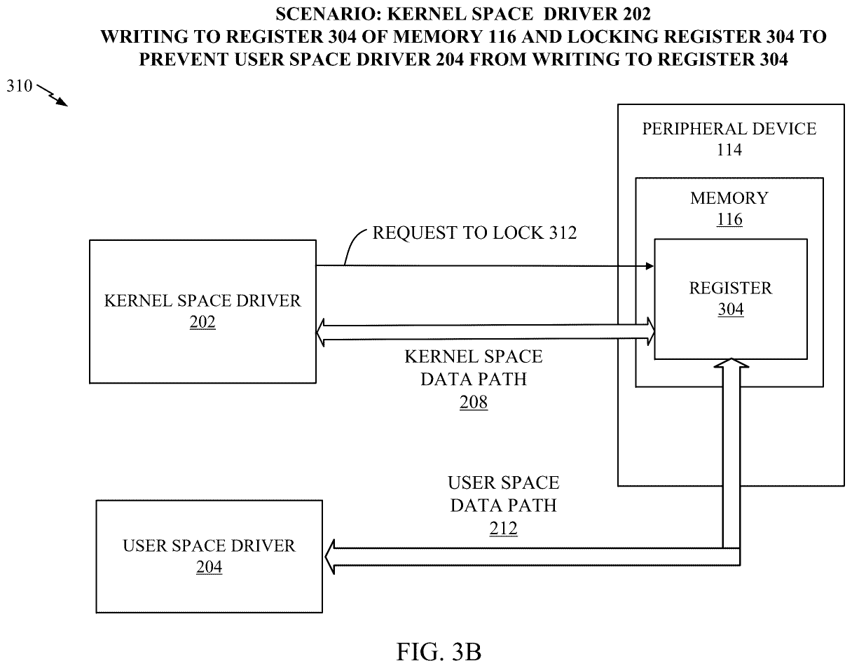

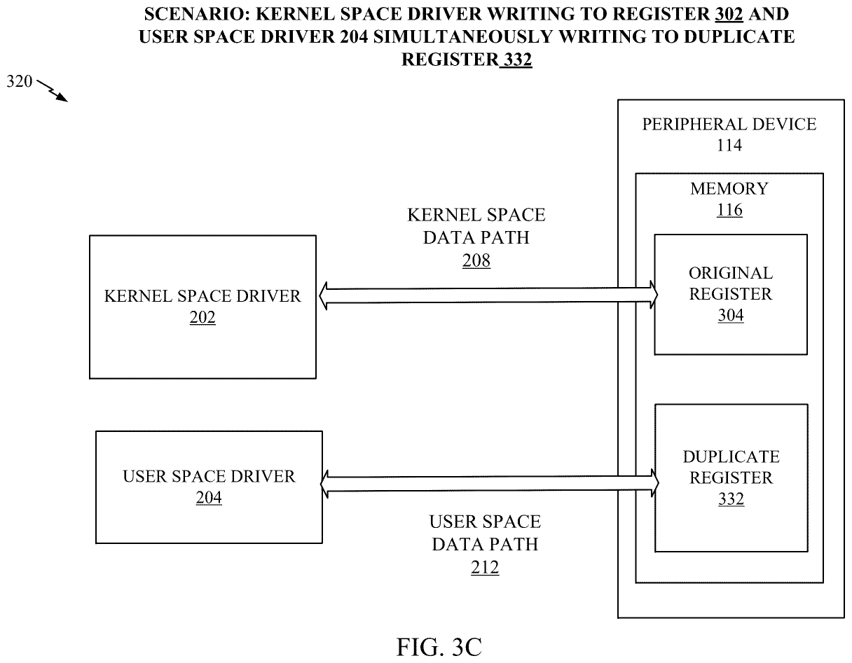

FIGS. 3A, 3B, and 3C illustrate different techniques for synchronizing a kernel space driver and a user space driver according to some aspects of the present disclosure. For simplicity, the different techniques will be discussed in conjunction with the kernel space driver 202, user space driver 204, and memory 116 discussed above with reference to FIGS. 2A, 2B, 2C, and 2D.

FIG. 3A illustrates a first technique 300 for synchronizing the kernel space driver 202 and the user space driver 204 according to some aspects of the present disclosure. For instance, the first technique 300 includes the kernel space driver 202 generating an interrupt 302 (e.g., labeled as blocking UIO interrupt) to the user space driver 204 when the kernel space driver 202 is accessing a register 304 of the memory 116 of the peripheral device 114 via the kernel space data path 208. For example, in some aspects, the kernel space driver 202 may generate the interrupt 302 immediately before the kernel space driver 202 accesses the register 304 via the kernel space data path 208. In some aspects, the kernel space driver 202 may issue the interrupt 302 to the user space driver 204 using the UIO framework of the kernel space (e.g., kernel space 102).

In some aspects, the kernel space driver 202 may stop generating the interrupt 302 when the kernel space driver 202 is no longer accessing the register 304 of the memory 116. In other aspects, the kernel space driver 202 may generate and provide a separate signal to the user space driver 204 to indicate that the kernel space driver 202 is no longer accessing the register 304. In such aspects, the user space driver 204 may access the register 304. In some aspects, the user space driver 204 may generate a similar interrupt to prevent the kernel space driver from attempting to access the register 304 while the user space driver 204 is accessing the register 304.

FIG. 3B illustrates a second technique 310 for synchronizing the kernel space driver 202 and the user space driver 204 according to some aspects of the present disclosure. For instance, the second technique 310 includes the kernel space driver 202 issuing a request 312 to the peripheral device 114 to lock the register 304 the kernel space driver 202 is accessing to prevent the user space driver 204 from simultaneously accessing the register 304. For example, in some aspects, the kernel space driver 202 may issue the request 312 immediately before the kernel space driver 202 accesses the register 304 via the kernel space data path 208.

In some aspects, the peripheral device 114 may unlock the register 304 when the kernel space driver 202 is no longer accessing the register 304 via the kernel space data path 208. For example, in some aspects, the kernel space driver 202 may cease issuing the request 312 when the kernel space driver 202 finishes accessing the register 304 of the memory 116, and the peripheral device 114 may, in turn, unlock the register 304 to the user space driver 204.

FIG. 3C illustrates a third technique 330 for synchronizing the kernel space driver 202 and the user space driver 204 according to some aspects of the present disclosure. For example, the third technique 330 may include generate duplicate register 332 of register 304. In this manner, the kernel space driver 202 may access the register 304 and the user space driver 204 may simultaneously access the duplicate register 332. Unlike the first technique 300 discussed above with reference to FIG. 3A and the second technique 310 discussed above with reference to FIG. 3B, the third technique 330 allows both drivers (e.g., kernel space driver 202 and user space driver 204) to write to a register (e.g, register 304 and duplicate register 332) at the same time and thus avoids latency caused by delays associated with both drivers attempting to access the same register at the same time using the separate data paths (e.g., kernel space data path 208 and user space data path 212).

### Example Method for Accessing Memory

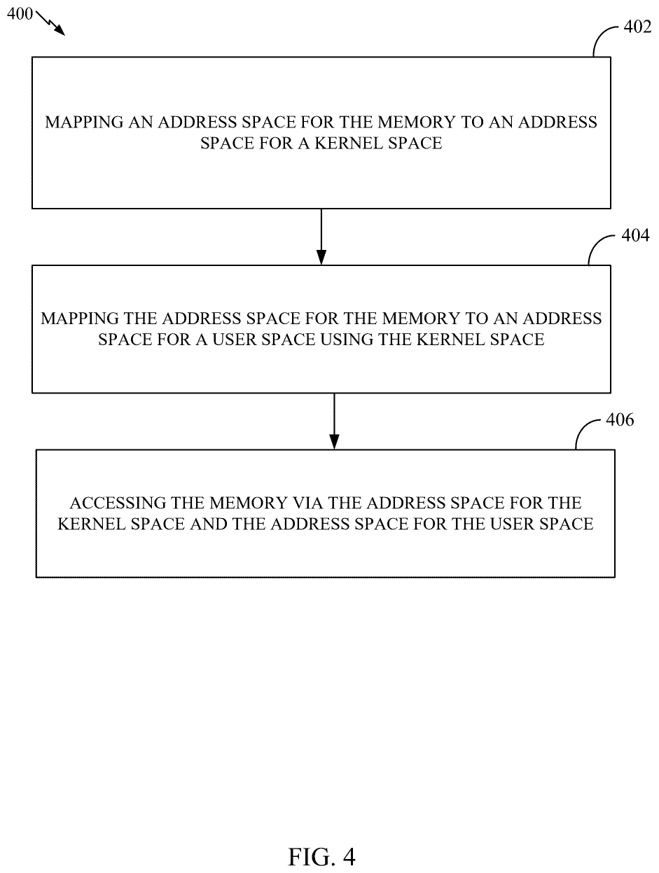

FIG. 4 is a diagram depicting an example method 400 of accessing memory of a peripheral device according to various aspects of the present disclosure. For example, the method 400 may be performed using any of the electronic device discussed above with reference to FIGS. 2A, 2B, 2C, and 2D. Furthermore, although FIG. 4 depicts steps performed in a particular order for purposes of illustration and discussion, the method 400 discussed herein is not intended to be limited to any particular order or arrangement. One skilled in the art, using the disclosure provided herein, will appreciate that various steps of the method 400 can be omitted, rearranged, combined and/or adapted in various ways without deviating from the scope of the present disclosure.

At 402, the method 400 includes mapping an address space for the memory of a peripheral device to an address space for a kernel space. For example, in some aspects, mapping the address space for the memory of the peripheral device to the address space for the kernel space may include a kernel space driver (e.g., the kernel space driver 202) mapping the memory-mapped regions (e.g., address space 126) of the memory (e.g., memory 116) of the peripheral device (e.g., peripheral device 114) into the address space (e.g., address space 106) of the kernel space (e.g., kernel space 102) to allow the kernel space driver to directly access and control the memory (e.g., registers) of the peripheral device.

At 404, the method 400 includes mapping the address space for the memory to an address space for a user space using the kernel space. For example, in some aspects, mapping the address space for the memory to the address space for the user space using the kernel space may include the kernel space driver remapping the mapped address space (e.g., mapped PCI address space 206) of the memory included in the address space of the kernel space to the user space (e.g., user space 104) using the UIO framework of the kernel space.

At 406, the method 400 includes accessing the memory via the address space for the kernel space and the address space for the user space. For example, in some aspects, accessing the memory via the address space for the kernel space and the address space for the user space may include the kernel space driver accessing the memory of the peripheral device using a kernel space data path (e.g., kernel space data path 208) based on the mapping at 402 and the user space driver accessing the memory of the peripheral device using a user space data path (e.g, user space data path 212) based on the mapping at 404.

In certain aspects, the method 400 may further include generating a duplicate of a register of the memory of the peripheral device such that the kernel space driver may access the original register and the user space driver may simultaneously access the duplicate of the original register.

In certain aspects, the method 400 may further include generating, by a first driver (e.g, kernel space driver or user space driver) in the kernel space or the user space, an interrupt for a second driver in the other of the kernel space or the user space while the first driver is accessing a register of the memory. In this manner, the interrupt may prevent the second driver from attempting to access the register of the memory while the register is being accessed by the first register.

In certain aspects, the method 400 may further include requesting, by a first driver (e.g., kernel space driver or user space driver) in the kernel space or the user space, the peripheral device lock write access to a register the first driver is accessing. In this manner, the method 400 may prevent a second driver in the other of the kernel space or the user space from accessing the register while the first register is accessing the register.

### Example Processing System

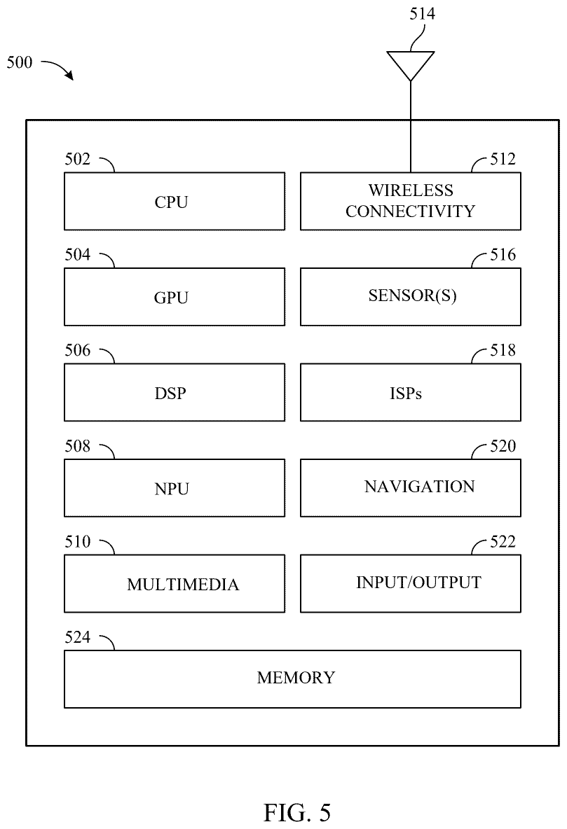

In some aspects, the components of the electronic devices depicted in FIGS. 2A, 2B, 2C, and 2D may be included in a device or processing system. FIG. 5 depicts an example processing system 500. Although depicted as a single system for conceptual clarity, in some aspects, as discussed above, the operations described below with respect to the processing system 500 may be distributed across any number of devices or systems.

The processing system 500 includes a central processing unit (CPU) 502. Instructions executed at the CPU 502 may be loaded, for example, from a memory 524 associated with the CPU 502.

The processing system 500 also includes additional processing components tailored to specific functions, such as a graphics processing unit (GPU) 504, a digital signal processor (DSP) 506, a neural processing unit (NPU) 508, a multimedia component 510 (e.g., a multimedia processing unit), and a wireless connectivity component 512.

An NPU, such as NPU 508, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS), as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

Generally, the processing system 500 and/or components thereof may be configured to perform the methods described herein.

Notably, in other aspects, elements of the processing system 500 may be omitted, such as where the processing system 500 is a server computer or the like. For example, the multimedia component 510, the wireless connectivity component 512, the sensor processing units 516, the ISPs 518, and/or the navigation processor 520 may be omitted in other aspects. Further, aspects of the processing system 500 may be distributed between multiple devices.

### Example Clauses

In addition to the various aspects described above, specific combinations of aspects are within the scope of the disclosure, some of which are detailed below:
Aspect 1: A method for accessing memory, comprising: mapping an address space for the memory to an address space for a kernel space; mapping the address space for the memory to an address space for a user space using the kernel space; and accessing the memory via the address space for the kernel space and the address space for the user space.
Aspect 2: The method of Aspect 1, wherein the accessing comprises: accessing, by a first driver running in the kernel space, the memory via the address space for the kernel space; and accessing, by a second driver running in the user space, the memory via the address space for the user space.
Aspect 3: The method of Aspect 2, wherein the first driver and the second driver are running on an electronic device.
Aspect 4: The method of Aspect 3, wherein the second driver is running on a virtual machine or a container.
Aspect 5: The method of Aspect 2, wherein: the first driver is running on a first electronic device; and the second driver is running in a container on a second electronic device.
Aspect 6: The method Aspect 5, wherein mapping the address space for the kernel space to the address space for the user space comprises mapping, by the second driver, the address space for the kernel space running on the first electronic device to the address space for the user space running on the second electronic device using a communication interface.
Aspect 7: The method of Aspect 6, wherein the communication interface comprises a memif interface.
Aspect 8: The method of any of Aspects 1 to 7, wherein the accessing comprises: accessing, by a driver running in the kernel space or the user space, a first register of the memory via the address space for the kernel space or the address space for the user space; and generating, by the driver, an interrupt during the accessing, the interrupt blocking another driver running in the other of the kernel space or the user space from accessing the first register of the memory via the other of the address space for the kernel space or the address space for the user space.
Aspect 9: The method of any of Aspects 1 to 7, wherein the accessing comprises: writing, by a driver running in the kernel space or the user space, a first register of the memory via the address space for the kernel space or the address space for the user space; and requesting, by the driver, the memory lock write access to the first register such that other drivers cannot write to the first register while the driver is writing to the first register.
Aspect 10: The method of any of Aspects 1 to 7, wherein the accessing comprises: accessing, by a first driver running in the kernel space or the user space, a first register of the memory via the address space for the kernel space or the address space for the user space; and generating a duplicate of the first register such that a second driver running in the other of the kernel space or the user space may access the duplicate of the first register file during the accessing by the first driver.
Aspect 11: A non-transitory computer-readable medium comprising instructions to be executed in a processor, wherein the instructions when executed in the processor cause the processor to perform a method for accessing memory, the method comprising: mapping an address space for the memory to an address space for a kernel space; mapping the address space for the memory to an address space for a user space using the kernel space; and accessing the memory via the address space for the kernel space and the address space for the user space.
Aspect 12: The non-transitory computer-readable medium of Aspect 11, wherein the accessing comprises: accessing, by a first driver running in the kernel space, the memory via the address space for the kernel space; and accessing, by a second driver running in the user space, the memory via the address space for the user space.
Aspect 13: The non-transitory computer-readable medium of Aspect 12, wherein the first driver and the second driver are running on an electronic device.
Aspect 14: The non-transitory computer-readable medium of Aspect 13, wherein the second driver is running on a virtual machine or a container.
Aspect 15: The non-transitory computer-readable medium of Aspect 12, wherein: the first driver is running on a first electronic device; and the second driver is running in a container on a second electronic device.
Aspect 16: The non-transitory computer-readable medium of Aspect 15, wherein mapping the address space for the kernel space to the address space for the user space comprises mapping, by the second driver, the address space for the kernel space running on the first electronic device to the address space for the user space running on the second electronic device using a communication interface.
Aspect 17: The non-transitory computer-readable medium of Aspect 16, wherein the communication interface comprises a memif interface.
Aspect 18: The non-transitory computer-readable medium of Aspect 11, wherein the accessing comprises: accessing, by a driver running in the kernel space or the user space, a first register of the memory via the address space for the kernel space or the address space for the user space; and generating, by the driver, an interrupt during the accessing, the interrupt blocking another driver running in the other of the kernel space or the user space from accessing the first register of the memory via the other of the address space for the kernel space or the address space for the user space.
Aspect 19: The non-transitory computer-readable medium of Aspect 11, wherein the accessing comprises: writing, by a driver running in the kernel space or the user space, a first register of the memory via the address space for the kernel space or the address space for the user space; and requesting, by the driver, the memory lock write access to the first register such that other drivers cannot write to the first register while the driver is writing to the first register.
Aspect 20: An apparatus, comprising: one or more processors configured to perform a method for accessing memory, the method comprising: mapping an address space for the memory to an address space for a kernel space; mapping the address space for the memory to an address space for a user space using the kernel space; and accessing the memory via the address space for the kernel space and the address space for the user space.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration. ” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining”may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S. C. § 112(f) unless the element is expressly recited using the phrase “means for” or, in the case of a method claim, the element is recited using the phrase “step for. ” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for accessing memory, comprising:
mapping an address space for the memory to an address space for a kernel space;
mapping the address space for the memory to an address space for a user space using the kernel space; and
accessing the memory via the address space for the kernel space and the address space for the user space.

2. The method of claim 1, wherein the accessing comprises:
accessing, by a first driver running in the kernel space, the memory via the address space for the kernel space; and
accessing, by a second driver running in the user space, the memory via the address space for the user space.

3. The method of claim 2, wherein the first driver and the second driver are running on an electronic device.

4. The method of claim 3, wherein the second driver is running on a virtual machine or a container.

5. The method of claim 2, wherein:
the first driver is running on a first electronic device; and
the second driver is running in a container on a second electronic device.

6. The method of claim 5, wherein mapping the address space for the kernel space to the address space for the user space comprises mapping, by the second driver, the address space for the kernel space running on the first electronic device to the address space for the user space running on the second electronic device using a communication interface.

7. The method of claim 6, wherein the communication interface comprises a memif interface.

8. The method of claim 1, wherein the accessing comprises:
accessing, by a driver running in the kernel space or the user space, a first register of the memory via the address space for the kernel space or the address space for the user space; and
generating, by the driver, an interrupt during the accessing, the interrupt blocking another driver running in the other of the kernel space or the user space from accessing the first register of the memory via the other of the address space for the kernel space or the address space for the user space.

9. The method of claim 1, wherein the accessing comprises:
writing, by a driver running in the kernel space or the user space, a first register of the memory via the address space for the kernel space or the address space for the user space; and
requesting, by the driver, the memory lock write access to the first register such that other drivers cannot write to the first register while the driver is writing to the first register.

10. The method of claim 1, wherein the accessing comprises:
accessing, by a first driver running in the kernel space or the user space, a first register of the memory via the address space for the kernel space or the address space for the user space; and
generating a duplicate of the first register such that a second driver running in the other of the kernel space or the user space may access the duplicate of the first register during the accessing by the first driver.

11. A non-transitory computer-readable medium comprising instructions to be executed in a processor, wherein the instructions when executed in the processor cause the processor to perform a method for accessing memory, the method comprising:
mapping an address space for the memory to an address space for a kernel space;
mapping the address space for the memory to an address space for a user space using the kernel space; and
accessing the memory via the address space for the kernel space and the address space for the user space.

12. The non-transitory computer-readable medium of claim 11, wherein the accessing comprises:
accessing, by a first driver running in the kernel space, the memory via the address space for the kernel space; and
accessing, by a second driver running in the user space, the memory via the address space for the user space.

13. The non-transitory computer-readable medium of claim 12, wherein the first driver and the second driver are running on an electronic device.

14. The non-transitory computer-readable medium of claim 13, wherein the second driver is running on a virtual machine or a container.

15. The non-transitory computer-readable medium of claim 12, wherein:
the first driver is running on a first electronic device; and
the second driver is running in a container on a second electronic device.

16. The non-transitory computer-readable medium of claim 15, wherein mapping the address space for the kernel space to the address space for the user space comprises mapping, by the second driver, the address space for the kernel space running on the first electronic device to the address space for the user space running on the second electronic device using a communication interface.

17. The non-transitory computer-readable medium of claim 16, wherein the communication interface comprises a memif interface.

18. The non-transitory computer-readable medium of claim 11, wherein the accessing comprises:
accessing, by a driver running in the kernel space or the user space, a first register of the memory via the address space for the kernel space or the address space for the user space; and
generating, by the driver, an interrupt during the accessing, the interrupt blocking another driver running in the other of the kernel space or the user space from accessing the first register of the memory via the other of the address space for the kernel space or the address space for the user space.

19. The non-transitory computer-readable medium of claim 11, wherein the accessing comprises:
writing, by a driver running in the kernel space or the user space, a first register of the memory via the address space for the kernel space or the address space for the user space; and
requesting, by the driver, the memory lock write access to the first register such that other drivers cannot write to the first register while the driver is writing to the first register.

20. An apparatus comprising:
one or more processors configured to perform a method for accessing memory, the method comprising:
mapping an address space for the memory to an address space for a kernel space;
mapping the address space for the memory to an address space for a user space using the kernel space; and
accessing the memory via the address space for the kernel space and the address space for the user space.
